(19) United States
(12) Patent Application Publication
(10) Pub. No.: US 2014/0062226 A1
(43) Pub. Date: Mar. 6, 2014

(54) SWITCHED RELUCTANCE MOTOR ASSEMBLY

(71) Applicant: SAMSUNG ELECTRO-MECHANICS CO., LTD., Suwon (KR)

(72) Inventors: Yong Wan Cho, Suwon (KR); Sang Ho Seo, Suwon (KR); Myung Geun Oh, Suwon (KR); Sung Tai Jung, Suwon (KR); Jung Kyu Yim, Suwon (KR)

(73) Assignee: SAMSUNG ELECTRO-MECHANICS CO., LTD., Suwon (KR)

(21) Appl. No.: 13/737,368

(22) Filed: Jan. 9, 2013

(30) Foreign Application Priority Data
Aug. 28, 2012 (KR) 10-2012-0094361

(51) Int. Cl. H02K 11/00

(52) U.S. Cl. CPC H02K 11/0021
USPC 310/43; 310/48

(57) ABSTRACT

Disclosed herein is a switched reluctance motor assembly including: a shaft forming the center of rotation of a motor; a rotor part rotatably coupled to the shaft; a balancing member including the rotor part and formed so as to enclose the shaft; a sensor magnet coupled to a lower end portion of the balancing member in an axial direction; and a printed circuit board having a hall sensor attached thereto so as to face the sensor magnet at a lower portion of the sensor magnet in the axial direction. According to the present invention, the coupling precision of the sensor magnet for sensing the position of the rotor part forming the rotor of the switched reluctance motor assembly may be improved.

### CROSS REFERENCE TO RELATED APPLICATION

This application claims the benefit of Korean Patent Application No. 10-2012-0094361, filed on Aug. 28, 2012, entitled “Switched Reluctance Motor Assembly”, which is hereby incorporated by reference in its entirety into this application.

### BACKGROUND OF THE INVENTION

1. Technical Field

The present invention relates to a switched reluctance motor assembly.

2. Description of the Related Art

Generally, a switched reluctance motor (SRM) called an SR motor is a motor in which both of a stator and a rotor have a magnetic structure, which is a salient pole, the stator has a concentrated type coil wound therearound, and the rotor is configured only of an iron core without any type of excitation device (a winding or a permanent magnet), such that competitive cost is excellent.

More specifically, the switched reluctance motor (SRM), which rotates a rotor using a reluctance torque according to a change in magnetic reluctance, has a low manufacturing cost, hardly requires maintenance, and has an almost permanent lifespan due to high reliability. The switched reluctance motor is configured to include: a stator part, which is a stator, including a stator yoke and a plurality of stator salient poles protruding from the stator yoke; and a rotor part, which is a rotor, including a rotor core and a plurality of rotor salient poles protruding from the rotor core so as to face the stator salient poles and rotatably received in the stator part.

Meanwhile, in order to control rotation of the switched reluctance motor, it is required to sense a position of the rotor part serving as the rotor of the motor. In the case of sensing the position of the rotor part, a sensing part for detecting the position may be coupled to a position corresponding to the rotor part. In the case in which this sensing part is not precisely fixed or a position error occurs at the time of assembling, an error may occur in the control of sensing of the rotor part, and driving reliability of the motor may be deteriorated. In addition, due to a structural limitation of the motor, it is difficult to add a separate coupling member to the motor, and productivity of a motor assembly product may be deteriorated by adding of the separate member.

### SUMMARY OF THE INVENTION

The present invention has been made in an effort to provide a switched reluctance motor assembly capable of improving reliability in controlling of the motor by improving coupling precision of a sensor magnet for sensing a position of a rotor part, which is a rotor of a motor assembly.

According to a preferred embodiment of the present invention, there is provided a switched reluctance motor assembly including: a shaft forming the center of rotation of a motor; a rotor part rotatably coupled to the shaft; a balancing member including the rotor part and formed so as to enclose the shaft; a sensor magnet coupled to a lower end portion of the balancing member in an axial direction; and a printed circuit board having a hall sensor attached thereto so as to face the sensor magnet at a lower portion of the sensor magnet in the axial direction.

The switched reluctance motor assembly may further include a balancing protrusion part extended downwardly from the balancing member in the axial direction to be formed integrally with the balancing member and coupled to the sensor magnet.

The balancing protrusion part may enclose the shaft and include at least one connection protrusion formed at an outer peripheral surface thereof.

The sensor magnet may include: a coupling groove coupled to the shaft; and a connection groove formed therein corresponding to the connection protrusion of the balancing protrusion part.

The switched reluctance motor assembly may further include: a first bearing part coupled to an upper portion of the balancing member in the axial direction; a front part supporting the first bearing part; a diffuser part coupled to an upper portion of the front part in the axial direction; and an impeller part coupled to an upper portion of the diffuser part in the axial direction and coupled to the shaft.

The switched reluctance motor assembly may further include a second bearing part coupled to a lower portion of the printed circuit board in the axial direction to support the shaft.

The switched reluctance motor assembly may further include: a housing formed so as to include the first and second bearing parts while enclosing an outer portion of the rotor part; and a cover member coupled to an upper portion of the housing in the axial direction.

The rotor part may include an annular rotor core and a plurality of rotor poles protruding outwardly from the rotor core.

The switched reluctance motor assembly may further include a stator part including a stator yoke receiving the rotor part and stator salient poles formed to be spaced apart from the rotor poles so as to correspond to the rotor poles and formed to be protruded inwardly of the stator yoke.

The balance member and the balance protrusion part may be formed integrally with each other by plastic injection molding

### BRIEF DESCRIPTION OF THE DRAWINGS

The above and other objects, features and advantages of the present invention will be more clearly understood from the following detailed description taken in conjunction with the accompanying drawings, in which:

FIG. 1 is a cross-sectional view of a switched reluctance motor assembly according to a preferred embodiment of the present invention;

FIG. 2 is an exploded perspective view of an assembly including a shaft according to the preferred embodiment of the present invention;

FIG. 3 is a plane view of a sensor magnet according to the preferred embodiment of the present invention; and

FIG. 4 is a cross-sectional view showing a state in which a rotor part and a stator part according to the preferred embodiment of the present invention are coupled to each other.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

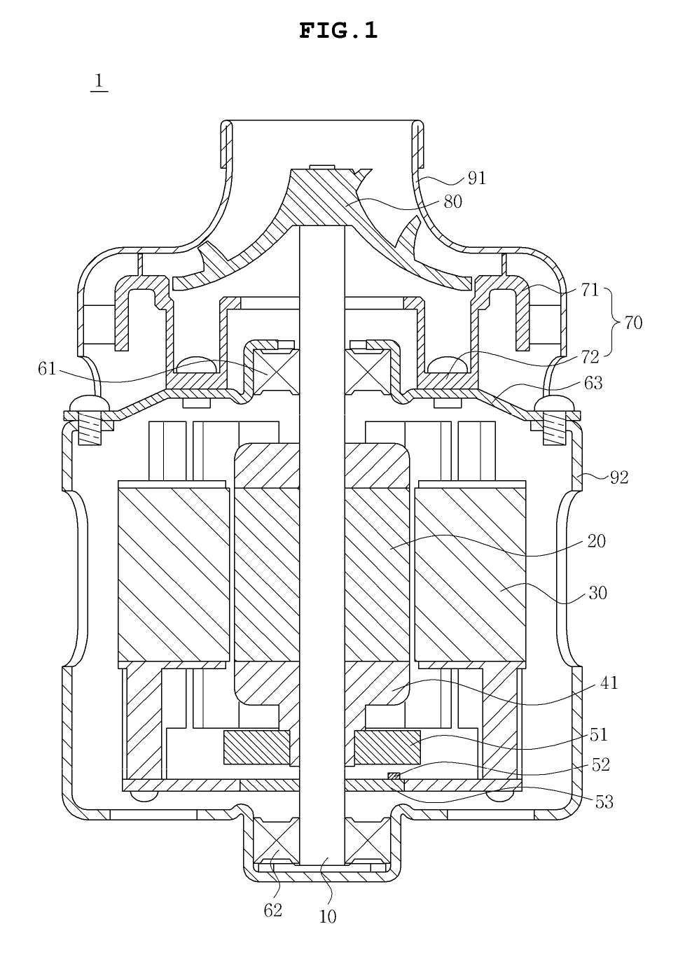

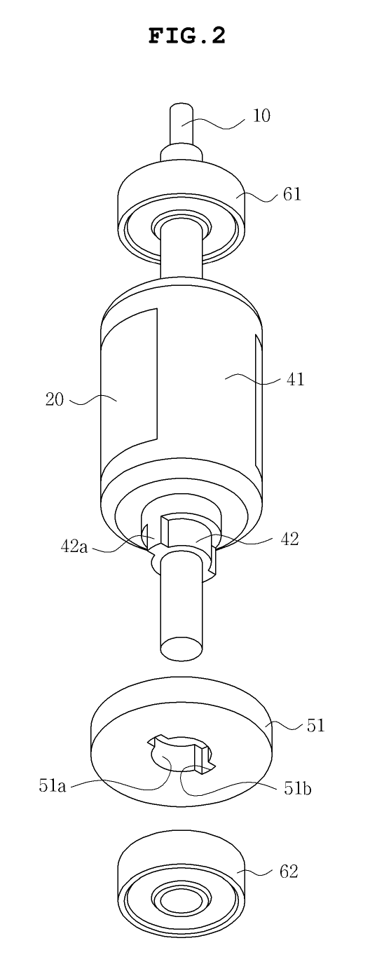

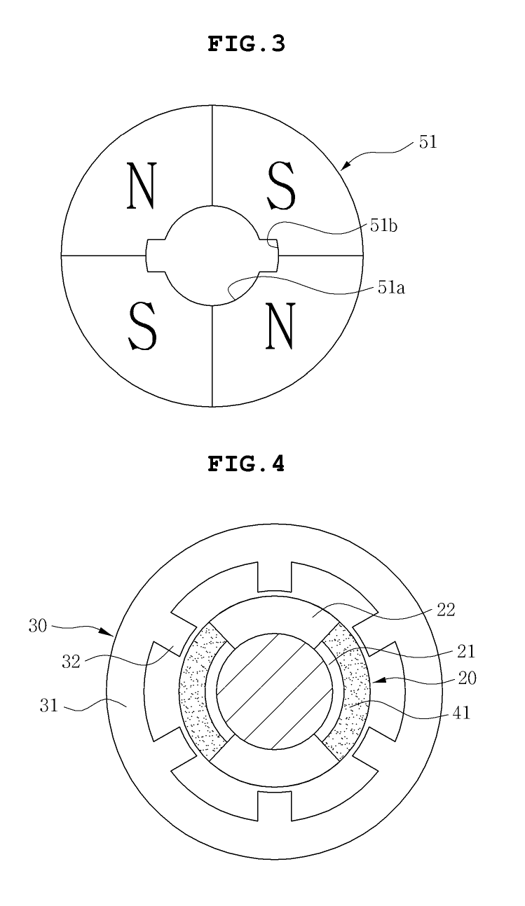

FIG. 1 is a cross-sectional view of a switched reluctance motor assembly according to a preferred embodiment of the present invention; FIG. 2 is an exploded perspective view of an assembly including a shaft according to the preferred embodiment of the present invention; FIG. 3 is a plane view of a sensor magnet 51 according to the preferred embodiment of the present invention; and FIG. 4 is a cross-sectional view showing a state in which a rotor part and a stator part according to the preferred embodiment of the present invention are coupled to each other.

The switched reluctance motor assembly 1 according to the preferred embodiment of the present invention may be configured to include a shaft 10 forming the rotation center of the motor; a rotor part 20 rotatably coupled onto the shaft 10, a balancing member 41 including the rotor part 20 and formed so as to enclose the shaft 10, a sensor magnet 51 coupled to a lower end portion of the balancing member 41 in the axial direction, and a printed circuit board having a hall sensor attached thereto so as to face the sensor magnet 51 at a lower portion of the sensor magnet 51 in the axial direction.

The shaft 10 forms the center of rotation of the motor and is extended in the axial direction. Particularly, the axial direction in the present invention, which is based on a direction in which the shaft 10 is formed, refers to directions toward upper or lower portions based on the shaft 10 shown in FIG. 1. A rotor part 20 to be described below is coupled to the shaft 10 forming the center of rotation of the motor.

As shown in FIGS. 1 and 4, the rotor part 20 may be configured to include an annular rotor core 21 and a plurality of rotor poles 22 protruding outwardly from the rotor core 21. The rotor core 21 has a hollow hole formed at a central portion thereof, and the shaft 10 is fixedly coupled to the hollow hole to transfer rotation of the rotor part 20 to the outside. The plurality of rotor poles 22 may be formed to be protruded outwardly along an outer peripheral surface of the rotor core 21 and be formed to correspond to stator salient poles 12b to be described below.

A stator part 30 is configured to include a stator yoke 31 and stator salient poles 32, as shown in FIG. 4. The stator yoke 31 may include a hollow hole formed therein so as to receive the rotor part 20 therein, and a plurality of stator salient poles 32 may be formed to be protruded from an inner surface of the stator yoke 31 and correspond to the rotor poles 22 of the rotor part 20. A current is applied to the stator salient poles 32 of the stator yoke 31 to form a magnetic flux path through the stator salient poles 32 and the rotor poles 22 of the rotor part 20 facing the stator salient poles 32, such that the rotor part 20 rotates.

The balancing member 41 may include the rotor part 20 and be formed so as to enclose the shaft 10. The balancing member 41 may be manufactured integrally with the rotor part 20 through injection molding so as to fill in the annular rotor core 21. As shown in FIG. 2, the balancing member 41 is formed integrally with the rotor part 20 by a method such as the injection molding method, or the like, such that a rotor pole 22 is formed so as to be exposed to the outside. As a balancing method, a method of cutting a portion of a balancing member 41 in order to maintain balancing at the time of the rotation of the motor or a method of coupling a separate weight member to a balancing member 41 may be used. In addition to the above-mentioned methods, various methods for rotation balancing of the motor may be selected and used by those skilled in the art. In addition, the balancing member 41 may be made of a plastic, or the like, or be formed integrally with the rotor part 20 through injection molding. In this case, the balancing member 41 may further include a balancing protrusion part 42 extended from the balancing member 41 for coupling and fixing a sensor magnet 51 to be described below.

The sensor magnet 51 may be coupled to a lower end portion of the balancing member 41 in the axial direction. The sensor magnet 51 is coupled to the balancing member 41, thereby making it possible to improve a degree of freedom in design of a coupling structure thereof. As the balancing member 41 is formed by the injection molding using plastic, various structures for coupling may be easily adopted. As shown in FIG. 2, the balancing protrusion part 42 formed integrally with the balancing member 41 may be coupled to the sensor magnet 51. The balancing protrusion part 42 includes at least one connection protrusion 42a formed on an outer peripheral surface, and the sensor magnet 51 includes coupling grooves corresponding to the connection protrusion 42a (See FIG. 3), such that fixation force of sensor magnet 51 is increased, thereby making it possible to further improve position precision of the sensor magnet 51 corresponding to the rotor part 20. Since the balancing protrusion 42 is formed together with the balancing member 41 in a process of injection molding of the balancing member 41, or the like, it may not be required to couple a separate member thereto, and various coupling structures for improving the coupling force may be easily adopted. Although the embodiment in which the outer peripheral surface of the balancing protrusion part 42 is provided with two connection protrusions 42a so as to be symmetrical to each other is shown in the present invention, it is obvious to those skilled in the art that connection protrusions 43 having various shapes may be used to improve coupling force with the sensor magnet 51 and the fixation force of the sensor magnet 51.

In the position sensing of the rotor part 20 according to the present invention, a position of the rotor part 20 may be detected using the sensor magnet 51 and the hall sensor 52 attached to the printed circuit board 53. The hall sensor 52, which is an element having a voltage varied according to strength of a magnetic field, uses a phenomenon (a hall effect) in which when a magnetic field is to formed vertically to a direction of a current flowing in a conductor, a potential difference is generated in a direction vertical to that of the current flowing in the conductor. Therefore, the sensor magnet 51 is formed so that N and S poles intersect with each other as shown in FIG. 3, and rotates together with the rotor part 20 installed to the shaft 10 according to the rotation of the rotor part 20 to sense magnetic fields of the N and S poles and sense the position of the rotor part 20, thereby making it possible to detect revolutions per minute (RPM). Since a method of sensing the rotor part 20 using the sensor magnet 51 and the hall sensor 52 is the same as a general sensing method of detecting a magnetic field of a magnet using a hall sensor, a detailed description thereof will be omitted.

Further, the switched reluctance motor assembly 1 according to the preferred embodiment of the present invention may further include a first bearing part 61 coupled to an upper portion of the balancing member 41 in the axial direction, a front part supporting the first bearing part 61, a diffuser part coupled to an upper portion of the front part in the axial direction, and an impeller part coupled to an upper portion of the diffuser part in the axial direction and coupled to the shaft 10.

The first bearing part 61 is a component rotating the rotor part 20 while supporting weight in the axial direction in the shaft 10 including the rotating rotor part 20 and a load applied to the shaft 10. The first bearing part 61 may be coupled to the upper portion of the balancing member 41 in the axial direction and be formed to be received in a motor housing to be described below.

The front part 63 may be formed of a separate member coupled to the housing 92 so as to be coupled to the upper portion of the first bearing part 61 in the axial direction to thereby support the first bearing part 61. The front part 63 may be coupled to the first bearing part 61 at a central portion thereof to support the first bearing 61 as shown in FIG. 1. However, a shape of the front part 63 is not limited thereto. That is, various structures of the front part 63 capable of supporting the first bearing part 61 may be selected and used by those skilled in the art.

Meanwhile, in the diffuser part 70, pressure of air sucked by an impeller part 80 to be described below increases in a diffuser 71 of the diffuser part 70, the air of which the pressure increases as described above is supplied to a return channel 72 disposed at a lower side through a space formed between an inner peripheral surface of the housing 92 covering an upper portion and an outer peripheral surface of the diffuser part 70, and the air supplied to the return channel 72 as described above is guided to a central portion by the return channels 72 and is blown toward the motor, such that the air is discharged while cooling the motor.

The impeller part 80 is coupled to an upper portion of the diffuser part 70 in the axial direction and is coupled to the shaft 10. The impeller part 80 is coupled to the shaft 10 to rotate together with the shaft 10 at the time of rotation of the motor, thereby sucking external air. Particularly, a vacuum cleaner including the switched reluctance motor assembly 1 is shown in FIG. 1. Here, the impeller part 80 rotates in order to introduce the air from the outside when the cleaner is operated. The impeller part 80 may be manufactured so as to have a direction and a shape of a blade formed at an inner side in order to introduce the external air. Since a detailed structure of the impeller part 80 may be easily designed and applied by those skilled in the art, a detailed description thereof will be omitted.

A second bearing part 62 may be coupled to the lower portion of the printed circuit board in the axial direction. The second bearing part 62 is also coupled so as to be disposed in the housing 92 together with the first bearing part 61. Since a description of specific functions and actions of the second bearing part 72 is overlapped with that of the first bearing part 61, it will be omitted.

In addition, the switched reluctance motor assembly 1 according to the preferred embodiment of the present invention may further include the housing 92 including the first and second bearing parts 61 and 62 while enclosing an outer portion of the rotor part 20 and a cover member 91 coupled to an upper portion of the housing in the axial direction.

The housing 92 is formed to be spaced apart from the rotor part 20, the balancing member 41, and the first and second bearing parts 61 and 62 so as to enclose the rotor part 20, the balancing member 41, and the first and second bearing parts 61 and 62. The housing 92 structurally protects components received therein, such as the rotor part 20, the stator part 30, and the like, and prevents other foreign materials from being introduced from the outside thereinto, thereby making it possible to improve reliability in the operation of the motor.

The cover member 91 is coupled to the upper portion of the housing 92 in the axial direction as shown in FIG. 1. A height at which the cover member 91 is coupled to the impeller part 80 is an important factor. The cover member 91 adjusts a height at which it is coupled to the upper portion of the impeller part 80, simultaneously with serving to cover the upper portion of the housing 92, thereby making it possible to improve the efficiency of the motor. To this end, an outer edge of the housing 92 is formed with a step part (not shown) capable of being coupled to the cover member, thereby making it possible to improve reliability in the height at which the cover member is coupled to the housing 92 at the time of coupling to the housing 92.

According to the preferred embodiment of the present invention, the coupling precision of the sensor magnet for sensing the position of the rotor part forming the rotor of the switched reluctance motor assembly may be improved.

In addition, the sensor magnet is coupled to the balancing protrusion part formed integrally with the balancing member formed integrally with the rotor part, such that precision of rotation sensing of the rotor part may be improved.

Further, the balancing member including the balancing protrusion part is formed integrally with the rotor part of the motor assembly by the injection-molding, such that coupling stability between the balance member and rotor part and coupling stability between the rotor part and the sensor magnet coupled together with the balancing member may be further improved.

Furthermore, the precision of position sensing of the rotor part of the motor assembly is improved, such that operation performance of the switched reluctance motor assembly may be further improved and the driving reliability thereof may be secured.

Moreover, the balancing member is formed integrally with the balancing protrusion part for coupling the sensor magnet together with the rotor part, such that productivity of the switched reluctance motor assembly may be improved and assembling precision and reliability of the switched reluctance motor assembly may be easily secured.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A switched reluctance motor assembly comprising:
a shaft forming the center of rotation of a motor;
a rotor part rotatably coupled to the shaft;
a balancing member including the rotor part and formed so as to enclose the shaft;
a sensor magnet coupled to a lower end portion of the balancing member in an axial direction; and
a printed circuit board having a hall sensor attached thereto so as to face the sensor magnet at a lower portion of the sensor magnet in the axial direction.

2. The switched reluctance motor assembly as set forth in claim 1, further comprising a balancing protrusion part extended downwardly from the balancing member in the axial direction to be formed integrally with the balancing member and coupled to the sensor magnet.

3. The switched reluctance motor assembly as set forth in claim 2, wherein the balancing protrusion part encloses the shaft and includes at least one connection protrusion formed at an outer peripheral surface thereof.

4. The switched reluctance motor assembly as set forth in claim 3, wherein the sensor magnet includes:
a coupling groove coupled to the shaft; and
a connection groove formed therein corresponding to the connection protrusion of the balancing protrusion part.

5. The switched reluctance motor assembly as set forth in claim 1, further comprising:
a first bearing part coupled to an upper portion of the balancing member in the axial direction;
a front part supporting the first bearing part;
a diffuser part coupled to an upper portion of the front part in the axial direction; and
an impeller part coupled to an upper portion of the diffuser part in the axial direction and coupled to the shaft.

6. The switched reluctance motor assembly as set forth in claim 1, further comprising a second bearing part coupled to a lower portion of the printed circuit board in the axial direction to support the shaft.

7. The switched reluctance motor assembly as set forth in claim 1, further comprising:
a housing formed so as to include the first and second bearing parts while enclosing an outer portion of the rotor part; and
a cover member coupled to an upper portion of the housing in the axial direction.

8. The switched reluctance motor assembly as set forth in claim 1, wherein the rotor part includes an annular rotor core and a plurality of rotor poles protruding outwardly from the rotor core.

9. The switched reluctance motor assembly as set forth in claim 8, further comprising a stator part including a stator yoke receiving the rotor part and stator salient poles formed to be spaced apart from the rotor poles so as to correspond to the rotor poles and formed to be protruded inwardly of the stator yoke.

10. The switched reluctance motor assembly as set forth in claim 2, wherein the balance member and the balance protrusion part are formed integrally with each other by plastic injection molding.
